(19) United States
(12) Patent Application Publication
(10) Pub. No.: US 2021/0035221 A1
(43) Pub. Date: Feb. 4, 2021

(54) Ideal expiration derivatives

(71) Applicant: Alexander Skabelin, New York, NY (US)

(72) Inventor: Alexander Skabelin, New York, NY (US)

(73) Assignee: Alexander Skabelin, New York, NY (US)

(21) Appl. No.: 16/531,080

(22) Filed: Aug. 4, 2019

(51) Int. Cl. G06Q 40/06

(52) U.S. Cl. CPC G06Q 40/06

(57) ABSTRACT

A financial instrument. A new type of financial product is disclosed. A method and system of administering a financial product where the pay-off of the product at expiration is based on a model value of some financial product expiring at a later date. The new product is named “ideal expiration derivative.” Ideal expiration derivatives, by design, are easier to hedge and risk manage. A method also includes generating, using the computer processor, prices, payments and/or hedges of ideal expiration derivatives.

### REFERENCES CITED

### U.S. Patent Documents

U.S. Pat. No. 8,788,381 B2 July 2014 Shalen
U.S. Pat. No. 8,447,679 B2 May 2013 Co et al.
U.S. Pat. No. 7,650,302 B2 January 2010 Nakayama
U.S. Pat. No. 7,996,269 B2 August 2011 Lange
U.S. Pat. No. 8,326,716 B2 December 2012 Hiatt et al.

### OTHER PUBLICATIONS

Fischer Black and Myron S. Scholes. “The Pricing of Options and Corporate Liabilities,” Journal of Political Economy, 81 (3), 637-654 (1973).
Merton, Robert (1973), “Theory of Rational Option Pricing”. Bell Journal of Economics and Management Science. 4 (1): 141-183.
John C Hull (2018). “Options, Futures, and Other Derivatives (10th Edition)”

### BACKGROUND OF THE INVENTION

A derivative is a contract that derives its value from the performance of an underlying entity. This underlying entity can be an asset, index, interest rate or any other quantity, and is often simply called the “underlying.” The value of the derivative at expiration is determined by the underlying and sometimes can have undesirable for hedging and risk management properties such as lack of continuity of sensitivity parameters. The sensitivity parameters are often called the greeks. The examples of such parameters are delta, gamma and vega. For example, standard call and put options have discontinuous delta at expiration which leads to random fluctuations of gamma from near zero values to extremely high values as you approach expiration. In order to avoid the bad behavior of risk sensitivities at expiration you would ideally like to unwind the position shortly before expiration, but such strategy is usually prohibitively expensive as you would have to pay additional bid-ask and other transaction costs if you unwind.

### SUMMARY OF THE INVENTION

“Ideal expiration derivative” that we introduce has value at expiration that depends on a model price of some financial instrument expiring at a later date. The above financial instrument as well as the model required to price it has to be specified beforehand. The expiration is in some sense “ideal” because the value of the “ideal expiration derivative” at expiration looks like and equal to the value of the specified instrument that would evolve according to the ideal rules of the specified model until its own expiration.

In one sense, this application discloses a financial product. According to various embodiments, the financial product comprises of a derivative security that has value at expiration that depends on a model price of some financial instrument expiring at a later date.

In other sense, this application discloses a method. According to various embodiments, the method comprises designing a financial product for the counterparty, client or personal use. The financial product comprises of an underlying derivative security that has value at expiration that depends on a model price of some financial instrument expiring at a later date.

In other sense, this application discloses a financial system. According to various embodiments, the financial system comprises a system configured to provide a financial product. The financial product comprises of an underlying derivative security that has value at expiration that depends on a model price of some financial instrument expiring at a later date.

The present invention also provides a method for managing risk associated with portfolio of ideal expiration derivatives. Ideal expiration derivatives are easier to risk manage and they can be priced as easily as standard derivatives.

Embodiments include, without limitation, methods for determining prices, hedges and risk of investment with ideal expiration features for a computer system configured to perform such methods, and computer-readable media storing instructions that, when executed, cause a computer system to perform such methods.

Additional or alternative embodiments may be particularly or wholly implemented on a computer-readable medium, for example, by storing computer-executable instructions or modules, or by utilizing computer readable data structures.

Furthermore, the methods and systems of the above-mentioned embodiments may also include other additional elements, steps, computer-executable instructions or computer-readable data structures. In this regard, other embodiments are disclosed and claimed herein as well.

This summary is not intended to identify key or essential features of the claimed subject matter, no is it intended to be used as an aid in determining the scope of the claimed subject matter.

This summary is illustrative only and is not intended to be in any way limiting.

The present invention is intended to overcome the drawbacks of the prior art. Other features and advantages of the invention will be apparent from the description, the drawings and the claims.

Financial derivatives are priced using financial models. One such model is Black-Scholes model where underlying is modeled as Brownian motion. The model value of the European call option in this framework is BS_call (S, K, r, vol, t) where S is the price of the underlying at expiration, vol is volatility, r is interest rate, t is time to maturity. Some other models assume that underlying has stochastic volatility, that underlying can have jumps etc. Model value of financial products can be computed using formulas or some other computational schemes such as simulations.

### DESCRIPTION OF THE DRAWINGS

FIG. 1 shows non-limiting example of a financial product with embedded ideal expiration. The pay-off of the standard European call option is illustrated in FIG. 1 by a solid line while the pay-off of the ideal expiration call option is illustrated by the dashed line.

FIG. 2 illustrates the pay-off of the standard European put option as demonstrated by a solid line while the pay-off of the ideal expiration put option is illustrated by the dashed line.

FIG. 3 illustrates the pay-off of the standard European digital option as demonstrated by a solid line while the pay-off of the ideal expiration digital option is illustrated by the dashed line.

FIG. 4 illustrates an operational flow representing example operations related to ideal expiration derivative.

FIG. 5 illustrates an operational flow representing example operations related to ideal expiration derivative.

FIG. 6 is a system block diagram illustrating the rating environment of example embodiments of the present invention.

### DETAILED DESCRIPTION OF THE INVENTION

Ideal expiration derivative is a financial product where the pay-off of the product at expiration depends on a model value of some financial product expiring at a later date. The particular model used should be specified in the financial contract.

Non limiting examples of the financial model is Black-Sholes model. In that model the price of the European call option BS_call is given by the formula:

C(Sₜ,t)=N(d₁)Sₜ−N(d₂)Ke^{-r(T-t)}

where

d₁=[In(Sₜ/K)+(r+σ²/2)]/(σsqrt(T−t))

d₂=[In(Sₜ/K)+(r−σ²/2)]/(σsqrt(T−t))

where K is the strike, T is the expiration time, a is the volatility of the underlying asset and r is the interest rate.

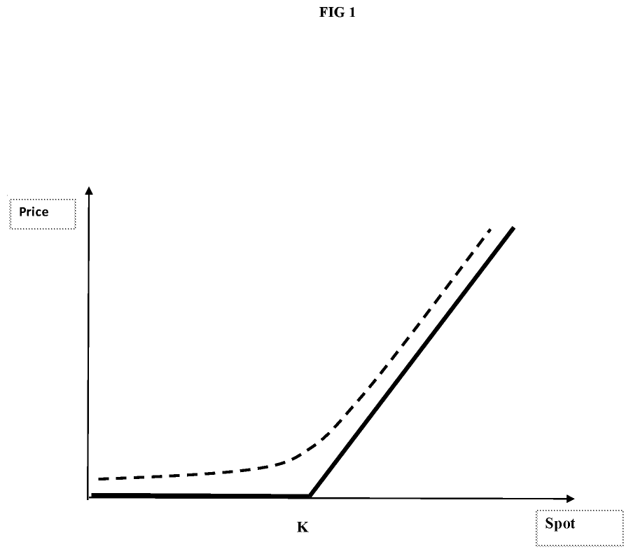

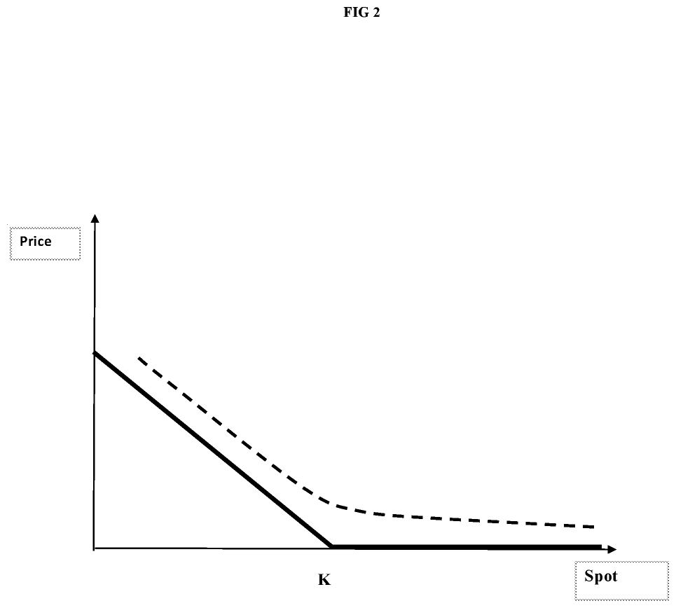

Non limiting examples of the products:
1. A derivative expiring in T1=1 month into cash with value equal to Black-Scholes model value of the European call option expiring in T2=one week with strike K=$100, annualized volatility 50% and interest rate r=0%. That is the value of the derivative at expiration equal to the value of Black-Sholes formula for European call option BS_call (S(T1), K=$100, r=0, vol=0.5, t=T2), where S(T1) is underlying price at derivative expiration time T1. The pay-off of the standard European call option is illustrated in FIG. 1 by a solid line while the pay-off of the ideal expiration call option is illustrated by the dashed line in FIG. 1.
   A pricer of this ideal expiration derivative can think of it as a regular European call option with strike K, expiring in time T1+T2 (1 month plus 1 week) where the last week before expiration interest rates were at idealistic constant rate r=0 and volatility is at idealistic and constant value vol=50%. The trade would effectively look like an investment in regular call option where you would unwind the position 1 week before the expiration to avoid challenging risk management just before the expiration but paid no bid-ask or other transaction fees usually associated with the un-wind. You can think of the underlying of this effective option evolving in real physical world for time T1 and then continue to evolve according to idealistic assumptions of Black-Scholes model for time T2.
2. A derivative expiring in T1=1 month into cash with value equal to Black-Scholes value of the European put option expiring in T2=one week with strike K=$100, annualized volatility 50% and interest rate r=0%. That is the value of the derivative at expiration equal to the value of Black-Sholes model value for European put option BS_put (S(T1), K=$100, r=0, vol=0.5, t=T2), where S(T1) is underlying price at derivative expiration time T1. A pricer of this ideal expiration derivative can think of it as a regular European put option with strike K, expiring in time T1+T2 (1 month plus 1 week) where the last week before expiration interest rates were at idealistic constant rate r=0 and volatility is at idealistic and constant value vol=50%. The pay-off of the standard European put option is illustrated in FIG. 2 by a solid line while the pay-off of the ideal expiration put option is illustrated by the dashed line in FIG. 2.
3. A derivative with knock-out barrier at $50 expiring in T1=1 month into cash with value equal to Black-Scholes model value of the knock-out barrier call option with the same barrier $50 expiring in T2=one week with strike K=$100, annualized volatility 50% and interest rate r=0%. A pricer of this ideal expiration derivative can think of it as a regular knock-out barrier call option expiring in time T1+T2 (1 month plus 1 week) where the value of the market parameters such as interest rate and volatility during the last week are set to their idealized values specified in the contract.

The model used in our non-limiting examples are Black-Scholes but any other model is within the scope of our invention.

The value of the ideal expiration derivative close to expiration approaches the model value of the contractually specified product that does not expire that soon. As a result, risk parameters of the ideal expiration derivative are more continuous than for any standard product that approaches expiration. This makes ideal expiration derivative easier to risk manage and their hedging costs are less.

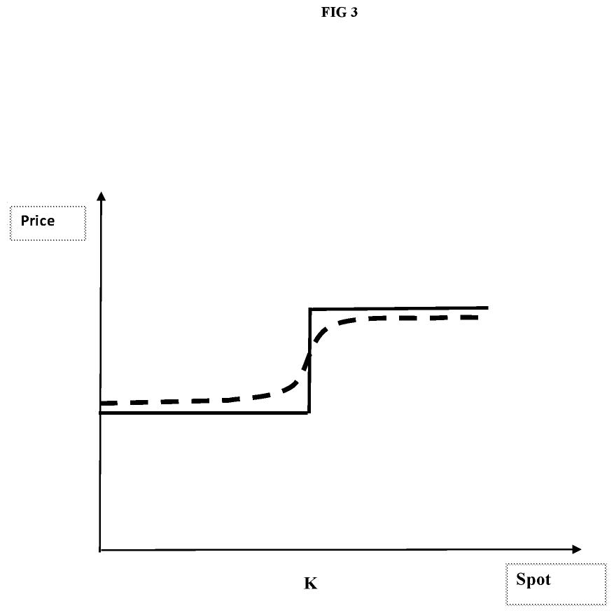

FIG. 3 illustrates the pay-off of the standard European digital option as demonstrated by a solid line while the pay-off of the ideal expiration digital option is illustrated by the dashed line. As the case with other pay-offs, the pay-off of the ideal option is a more smooth function of the underlying price, which results in better risk managemet properties.

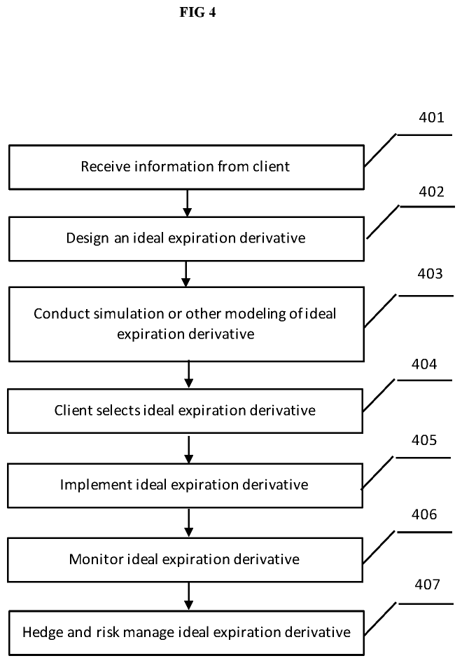

FIG. 4 is a flow chart depicting a method for creating an ideal expiration derivative according to exemplary embodiment of the invention. In step 401 a market participant receives information from the client about the requirements and desired parameters of the financial transaction. In step 402 a market participant designs an ideal expiration derivative in line with the requirements received in step 401. In step 403 a market participant conducts a simulation or other modeling of the an ideal expiration derivative and derives pricing and risk parameters. In step 404 the client selects the final product and parameters that satisfies his needs. In step 405 a market participant implements an ideal expiration derivative agreed with the client in step 404. A market participant monitors an ideal expiration derivative in step 406 and hedges risk in 407. Some of the steps are optional and the order of the events could vary.

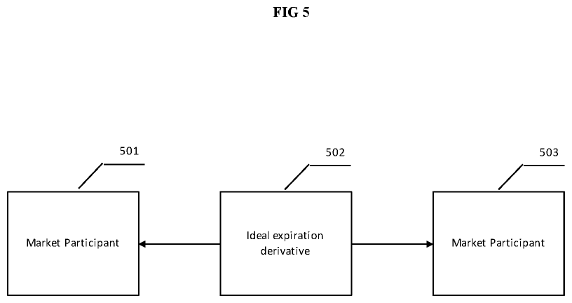

FIG. 5 shows a system block diagram of an example embodiment of the present invention. Market participant 501 trades an ideal expiration derivative product 502 with market participant 503.

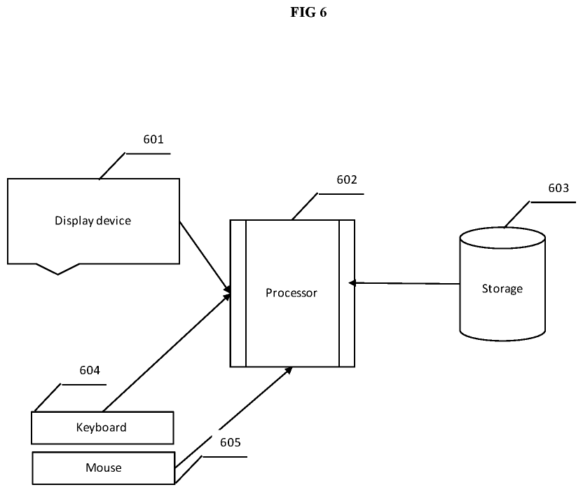

FIG. 6 illustrates a typical operating environment for embodiments of the present invention. 602 is an instruction execution or processing platform. The system includes a fixed storage medium, illustrated graphically at 603, for storing programs that make up computer program code, which enables the modeling algorithm and any other calculations that may be used with the embodiment of the invention. Instruction execution platform 602 of FIG. 6 can execute the appropriate instructions and display appropriate screens on display device 601. These screens can include user input screens for entering various parameters, using such input devices as keyboard 604 and mouse 605.

### CONCLUSION

The forgoing description of embodiments has been presented for purposes of illustration and description of the ideal expiration derivatives. The foregoing description of the financial product is not intended to be exhaustive or to limit embodiments to the precise form explicitly described or mentioned herein. Modifications and variations are possible in light of the above teachings or may be acquired from practice of various embodiments.

Some steps illustrated in the figures could be optional or could be performed in a different order. The embodiments described herein were chosen in order to describe the principals of various embodiments, their nature and the practical application to enable one skilled in the art to make and use these and other embodiments with various modification as are suited for the particular use contemplated. Any and all permutations of features from the above described embodiments are there within the scope of the invention.

Although the subject matter has been described in language specific to structural feature and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A method for investing funds of an investor, the method comprising:
conducting, by a computer system, a number of computer-implemented calculations to determine market value and/or return characteristics for potential investments of the funds into ideal expiration products with pay-off at expiration dependent on a model value of some financial product, wherein the computer system comprises a processor and computer-readable medium, and is programmed to perform calculations;
investing the funds of the investor in a ideal expiration instrument;
estimating market risk exposures of the ideal expiration portfolio using one or more computer-implemented quantitative analysis, wherein the computer-implemented quantitative analysis is performed by the computer system;

2. The method of claim 1, where ideal expiration portfolio comprises a fund of funds.

3. The method of claim 1, where ideal expiration portfolio comprises funds of hedge funds.

4. The method of claim 1, where investment comprises entering into derivative contracts that have ideal expiration features of have underlying instruments with ideal expiration features.

5. The method of claim 1, wherein the computer system comprises a personal computer.

6. The method of claim 1, wherein the computer system comprises a server.

7. The method of claim 1, wherein the computer system comprises a computational device such as smart phone, Ipad, tablet or smart watch.

8. The method of claim 1, wherein any of the instruments have an ideal expiration feature, i.e. where the pay-off of the financial instrument at expiration depends on a model price of some financial instrument expiring at a later date.

9. A computer-readable, non-transitory, tangible medium having computer executable instructions for performing a computer implemented method for creating and operating a financial product with ideal expiration features, the computer-readable medium comprising:
computer-readable program code for calculating market value, return characteristics and risk exposures.
